(19) United States
(12) Patent Application Publication
(10) Pub. No.: US 2008/0295947 A1
(43) Pub. Date: Dec. 4, 2008

(54) METHOD FOR ULTRASONIC WELDING AND ULTRASONIC WELDING FASTENER AND JOINING SYSTEMS

(76) Inventors: Alain BOURBEAU, Drummonville (CA); Germain Belanger, St-Germain-De-Grantham (CA)

Correspondence Address: GOUDREAU GAGE DUBUC, 2000 MCGILL COLLEGE, SUITE 2200, MONTREAL, QC, H3A 3H3, CA

(21) Appl. No.: 11/756,794

(22) Filed: Jun. 1, 2007

(51) Int. Cl. B29C 65/08

(52) U.S. Cl. 156/73.1; 428/385

(57) ABSTRACT

There is provided a method for forming joints between components, comprising selecting the components; selecting an ultrasound emitting source; and exposing a region of contact between the components to ultrasounds emitted by the ultrasound emitting source, to form a melted phase, a structural interface at the region of the joint being formed by engagement of the melted phase with the components. The two components may be of similar or dissimilar materials.

### BACKGROUND OF THE INVENTION

Coated abrasive and non-woven abrasives materials are usually produced in large rolls from which a desired commercial product is cut by an automated process. Most useful forms are abrasive belts and disks for example.

For many years, endless abrasive belts have been made by splicing the ends of lengths of coated abrasive and non-woven abrasive sheet materials.

Four types of splices are common: 1) lap joint made by profiling each end such that when overlapped and joined with adhesive, which is preferably urethane, on a heated press, the belt having a uniform cross-sectional thickness across the joined area; 2) overlap top skived joint, similar to the lap joint, except that the layer of grain above the joint is removed by grinding; 3) butt joint, wherein the two ends are scuffed on the non-abrasive surface and are butted together, with no overlap, to form an endless belt; a very strong thin reinforcing and tear-resistant tape, with adhesive on the surface thereof, is placed on the back of the butt joint and put in a heated press to activate and cure the adhesive, which is preferably urethane; 4) interlocking joint, similar to a regular butt joint, except that the two ends of the belt have a wavy cut and interlock in each other.

Typical materials used for abrasive belts are coated abrasives (grain coated on polyester cloth, cotton cloth, rayon cloth, paper, polyester film) or non-woven scrim reinforced abrasives (grain coated inside and above the 3-dimensional plastic fiber web).

Plastic button may be welded on abrasive discs made of a non-woven material by spin welding or vibration welding. Non-woven abrasive discs have on the front side a lofty non-woven open web material formed of synthetic fibers and abrasive particles. The web is needle tacked to an open weave scrim backing and impregnated with resin and abrasive.

In the field of plastic welding, ultrasonic methods have not been developed since it has been established that these methods are only efficient in the case of two components having a molecular structure compatibility. Besides, ultrasonic means involve generating very high frequency waves and require adjustments according to the type of materials to weld.

In the cases of disks, when the components to be welded are not identical, ultrasonic methods have usually been discarded. Generally, in the cases of belts, adhesive tapes reinforced with structural filaments, which curing is achieved under pressure and heat inside a hot press, are used. This technique proves to involve time wasting surface preparation and finishing.

There is still a need in the art for a method for ultrasonic welding and ultrasonic welding fastener and joining systems.

### SUMMARY OF THE INVENTION

There is provided a method for making a joint between a first and a second components using ultrasounds, comprising the steps of selecting a first material and a second material; selecting an ultrasound-emitting source; optimizing parameters of the ultrasound emitting source; and exposing a region of the joint to ultrasounds emitted by the ultrasound emitting source; thereby forming a structural interface by melting at the region of the joint between the first and the second components.

There is further provided a joint between a first and a second components made in one of: i) coated abrasive materials and ii) non-woven scrim reinforced abrasive materials, the joint comprising a region of the first component in contact with a region of the second component, and a bond generated by exposure to ultrasounds of a film of ultrasound sensitive material placed in the region of contact.

There further provided a joint between a first component made in one of: i) coated abrasive materials and ii) non-woven scrim reinforced abrasive materials, and a second component made in one of: i) metallic material and ii) plastic material), the joint comprising a region of the first component in contact with a region of the second component, and an interfacial bond generated by exposure of the region of the first component in contact with the region of the second component to ultrasounds.

There is further provided a joint between a first component made in one of: i) coated abrasive materials and ii) non-woven scrim reinforced abrasive materials, and a second component made in one of: i) metallic material and ii) plastic material), the joint comprising a film of ultrasound sensitive material in contact with both components, and an interfacial bond generated by exposure of the film of ultrasound sensitive material to ultrasounds.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1a) illustrates a butt joint between non-woven scrim reinforced abrasive belt material pieces by a thermoplastic film supported by a polyester tape; FIG. 1b) illustrates an overlap joint between a first and a second non-woven scrim reinforced abrasive belt material pieces by insertion of a thermoplastic film; FIG. 1c) illustrates an alternative of the butt joint of FIG. 1;

FIG. 2a) illustrates a butt joint between coated abrasive belt material pieces by a thermoplastic film supported on a polyester tape; FIG. 2b) illustrates a butt joint between coated abrasive belt material pieces having a cloth liner and a first thermoplastic film co-laminated on a backface thereof to generate a bond to a second thermoplastic film deposited on a polyester tape overlapping the joint;

FIG. 3a) illustrates a nylon button welded on a non-woven scrim reinforced abrasive disk material; FIG. 3b) illustrates a nylon button welded on a coated abrasive disk material co-laminated with a cloth liner and a thermoplastic film on a backface thereof; FIG. 3c) illustrates a nylon button welded on a coated abrasive disk material;

FIG. 4a) illustrates a metal button welded to a non-woven scrim reinforced abrasive disk material using a thermoplastic film on the metal button; FIG. 4b) illustrates a metal button welded to a coated abrasive disk material co-laminated with a thermoplastic film; and

FIG. 5 shows a table of results of lap shear tests on nylon button welded on disks.

### DESCRIPTION OF EMBODIMENTS OF THE INVENTION

There is provided a method for welding materials together, such as abrasive belt materials together for example, and for welding on materials such as on abrasive disk materials, for example, using ultrasonic methods.

Ultrasonic methods typically comprise applying a vibratory mechanical pressure at ultrasonic frequencies at the interface between two components to be bonded together. Electrical energy is converted to ultrasonic vibrations through the use of a transducer. The vibratory pressure at the interface in the welding area generates frictional heat and melts the materials at the interface.

The present method generally provides bonding components together using ultrasounds.

The method comprises the steps of selecting the first and second components; selecting an ultrasound emitting source; and exposing a region of contact between the two components to ultrasounds emitted by the ultrasound emitting source; thereby forming a structural interface at the region of the joint between the first and a second components.

The step of selecting the first and second components comprises selecting at least one component made in a material having at least a part with a melting temperature that can be reached under exposure to ultrasounds.

The step of selecting an ultrasound emitting source comprises selecting an ultrasound emitting source according to first and second components, adapting the shape and geometry of the ultrasound emitting source according to the bond to be made and optimizing the parameters of the exposure to ultrasounds, including pressure, power, time of exposure, delay before withdrawal of the tip ultrasound emitting source (hold time of the tip), according to the frequency of the ultrasound emitting source.

The structural interface at the region of the joint is formed by engagement of a melted part of the material of at least a first one of the component with the material of the second component. Partial melting may be reached in both components.

The two components may be of similar or dissimilar materials.

For example the method allows welding a nylon button on a polyester fabric material under emission of ultrasounds under a pressure of 20 lbs at 80% of an ultrasound-emitting source of 20 kHz, during 1.75 seconds.

Depending on the flexibility allowed in the step of selecting the components and/or in the step of selecting ultrasound emitting source for example, or on a target resistance of the bond, the present method may further comprise selecting a film of insertion material and inserting the selected film in the region of the bond to be achieved between the two components, either in the plane of the bond or transversally to the plane of the bond in the case of a transverse joint for example.

Although components of similar materials may usually be welded together using ultrasounds, using an insertion material having a lower melting temperature than the materials of the components may be suitable to avoid using temperatures that could damage one of the components, for example.

The selected film may be mechanically deposited, by lamination for example, on a face of at least one of the components to be bonded together, or at the interface between the two components to be bonded together.

In the case of abrasives materials produced in large rolls for example, the selected film may be mechanically deposited on the total surface of one face of the materials or laminated between the backface of the material and a cloth liner, as will be described hereinbelow.

People in the art will appreciate that such a feature results in reduced loss rates at the stage of disks and belts cut-out from complete rolls for example. Disks may be cut out, and buttons welded thereon anywhere is needed using ultrasound directly, since the material already comprises the selected film.

Therefore, the method may comprise continuously laminating a film of a selected insertion material on an abrasive fabric, with or without surface preparation by cleaning and sanding for example, and then proceed to the cut-out of the desired abrasive pieces according to target surface geometries. These pieces will thus be ready-to be welded.

Alternatively, the method may comprise continuously co-laminating a surface coating fabric such as a cloth liner on the backside of the abrasive fabric, with or without surface preparation by cleaning and sanding for example, with the film of selected insertion material sandwiched therebetween, welding by ultrasound, and then proceed to the cut-out of the desired abrasive pieces according to target surface geometries. The cloth liner is found to prevent shredding of the abrasive fabric. It may also be used for aesthetic purposes or printing purposes for example.

The amount of insertion material, i.e, the thickness of the film, may be adjusted to allow the subsequent joining step, such as welding a disc button or splice taping using ultrasounds.

Under action of the ultrasounds, the material of the insertion film reaches its melting temperature, melts, and the melted material from the sandwiched film gets into contact with the material to be bounded, which itself is non-compatible with ultrasounds, thereby generating a structural bond. In case of a co-laminated cloth liner, the cloth liner is selected to be of open weave, i.e. not too closely woven, so as to allow the melted material from the sandwiched film to go therethrough.

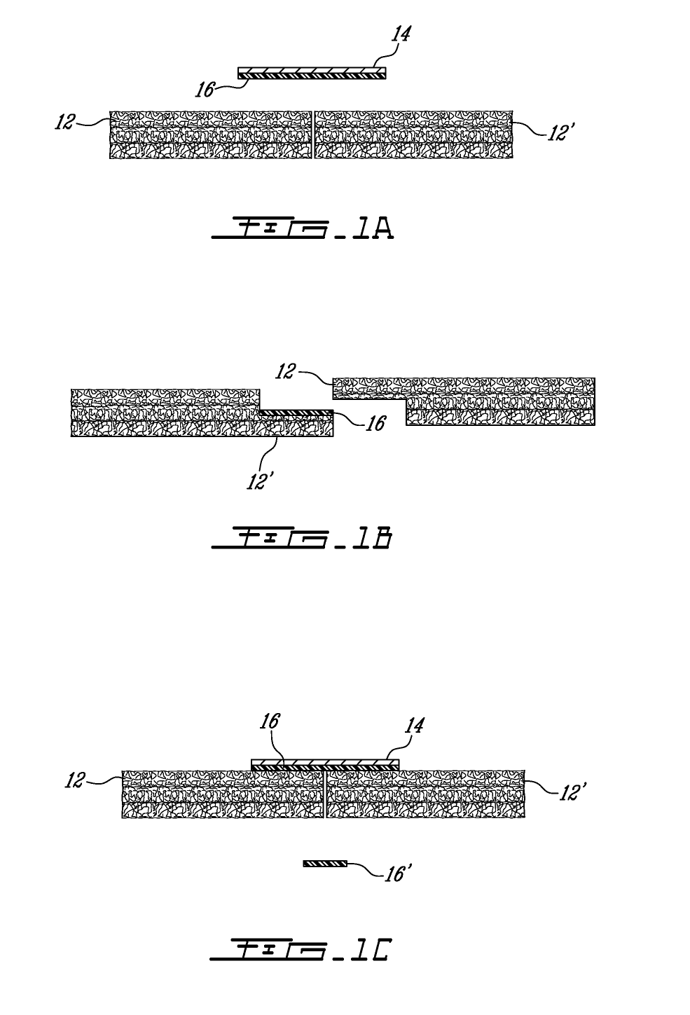

The examples of FIG. 1 illustrate splicing joints in a non-woven scrim reinforced abrasive belt.

In FIG. 1a), the non-woven scrim reinforced abrasive material pieces 12 and 12′ are bonded together in a butt joint by an overlapping tape 14 supporting an insertion film 16.

The supporting tape 14 may be a polyester tape, a fiberglass tape, a polyester fabric, a fiber reinforced polyester splicing tape for example. The supporting tape is to withstand stretching forces, which may appear when the belt is in use.

The insertion film 16 may be a thermoplastic film or a thermoset plastic for example.

In FIG. 1b), a first and a second non-woven scrim reinforced abrasive material pieces 12 and 12′ are bonded together in an overlap joint by insertion of an insertion film 16; in this case, the insertion film 16 may be omitted, since typically the layer of grain above the joint is removed by grinding.

FIG. 1c) shows a butt joint of the type of FIG. 1a), which is reinforced, in a further step, by a second joint formed by submission of a second thermoplastic film (which may be different from the first thermoplastic film used in the butt joint according to FIG. 1a) on the side of the grains of the non-woven scrim reinforced abrasive belt material pieces 12 and 12′ to ultrasounds. Compared to the butt joint of FIG. 1a), the joint of FIG. 1c) is thus reinforced, the joint being prevented from breaking in case the first butt joint on the opposite side peels during rolling or other use of the belt.

It is to be noted that the strength of the bonding depends on the careful selection of the material of the insertion film according to the nature of the two materials to be welded together and on the matching geometry of the tip of the ultrasound transducer used.

For example, a splicing joint in an abrasive belt may be formed as follows. First, a film of polyurethane of a thickness of 0.008 inches is colaminated on a polyester abrasive belt material with a cloth liner, under a pressure of 6 bars, a temperature of 200° C. a rate of 1.5 inch/s. Then, a polyester film reinforced with polyester yarns, colaminated with a polyurethane film of a thickness of 0.008 inches, is deposited at the region of the splice, and the region is submitted to ultrasounds under a pressure of 20 lbs, at a amplitude of 100%, during 5 seconds, using an ultrasound emitting source of 20 kHz.

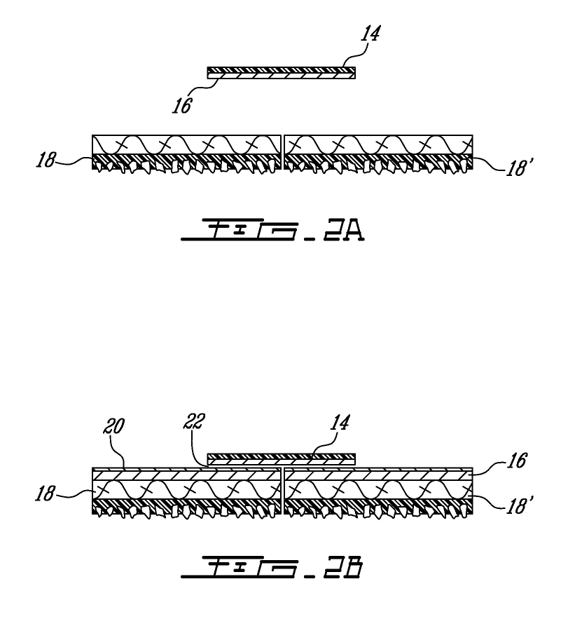

FIG. 2a) illustrates the case of a standard coated abrasive belt, where two coated abrasive belt material pieces 18, 18′ are welded together in a butt joint by a tape 14 supporting an insertion film 16. The coated abrasive material may be made of polyester cloth, cotton cloth, poly-cotton cloth, polyester film or paper for example, and with or without surface preparation.

FIG. 2b) illustrates the case of a laminated belt, wherein the insertion film 16 is co-laminated with a cloth liner 20 on the back face of the coated abrasive belt material pieces 18, 18′, which is previously prepared. A bond is then generated between the insertion film and an overlapping tape 14. The cloth liner 20, of open weave, contributes to reinforce the bond as mentioned hereinabove. Depending on the target bond strength for the belt to be produced, an additional insertion film 22 may be required under the splicing tape to provide further resistance to the welded joint.

For welding buttons to disks using ultrasounds, extra care is required to yield a target adhesion level, taking into account the uneven thickness of the buttons, which may result in overheating in thinner regions thereof and in the region of the disk material where the button is welded. The heat distribution on the surface of the tip of the transducer needs be first calibrated, so as to achieve a uniform fusion temperature on the whole surface of the button.

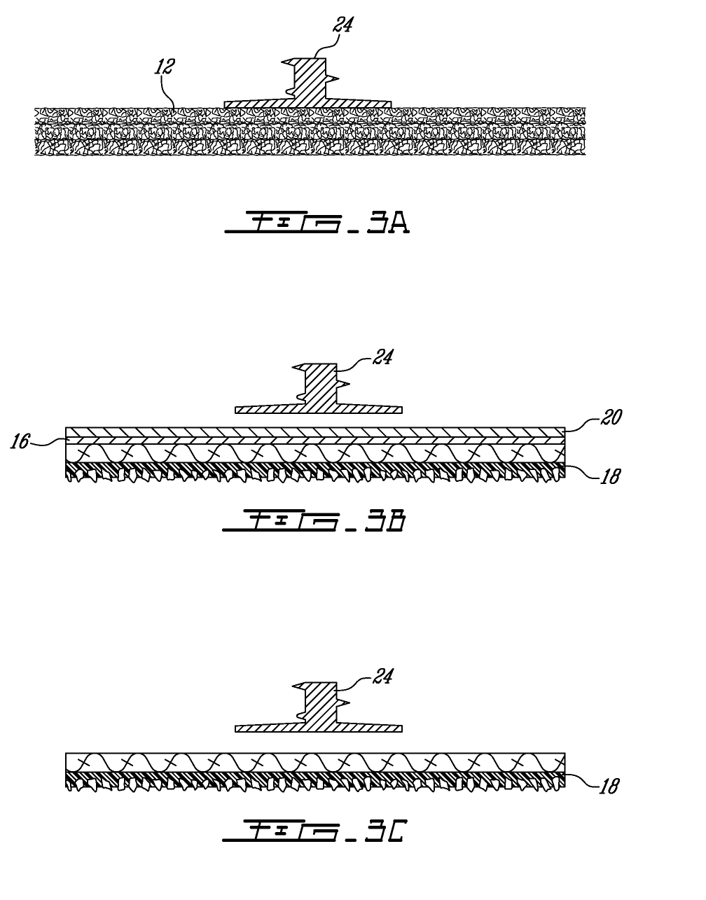

FIG. 3a) illustrates the case of a nylon button 24 welded on a non-woven scrim reinforced abrasive disk material 12 without surface preparation.

FIG. 3b) illustrate the case of a nylon button 24 welded on a coated abrasive disk material 18, made of polyester cloth, cotton cloth, poly-cotton cloth, polyester film or paper for example, and with or without surface preparation, the coated abrasive disk material 18 being co-laminated with an insertion film 16 and a cloth liner 20 (for further reinforcement of the joint, in particular in case the abrasive disk material is damaged in the region of the button due to the ultrasound exposure, which may result in a lack of resistance of the disk in use. Lamination of a cloth liner 20 provides body and shredding resistance to the disk in use.

FIG. 3c) illustrate the case of a nylon button 24 welded directly on a coated abrasive disk material 18, made of polyester cloth, cotton cloth, poly-cotton cloth, polyester film or paper for example, and with or without surface preparation.

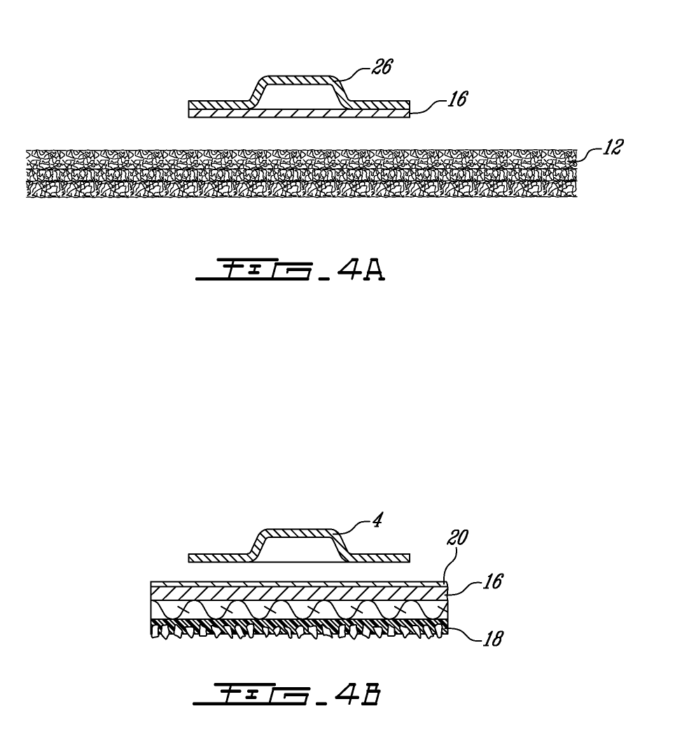

In FIG. 4a), a metal button 26 is welded to a non-woven scrim reinforced abrasive disk material 12 without surface preparation using an insertion film 16.

In FIG. 4b), a metal button 26 is welded to a coated abrasive disk material 18, made of polyester cloth, cotton cloth, poly-cotton cloth, polyester film or paper for example, and with or without surface preparation, co-laminated with an insertion film 16 and a cloth liner 20.

In both previous cases, an ultrasound transducer may be used, or a heating device having a shape reverse from that of the button, or the shape of the tape, may be used.

The quality of the bonding between the metal button on the non-woven material or the coated material is directly dependent on the nature of the film 16, the geometry of the tip of the transducer and the laminating steps parameters. More precisely, the film 16 must be uniformly activated at a precise temperature (melting temperature) and a uniform pressure applied on the button, in order to yield a strong adhesion.

A nylon button may thus be welded on a polyester abrasive disk material as follows. First, a film of polyurethane of a thickness of 0.008 inches is colaminated on a polyester abrasive disk material with a cloth liner, under a pressure of 6 bars, a temperature of 200° C. at a rate of 1.5 inch/s. Then, a nylon button is put in place on the polyester abrasive disk material and submitted to ultrasounds under a pressure of 20 lbs, at an amplitude of 100% and a frequency of 20 kHz, during 3.5 seconds.

The present method therefore provides assembling together a variety of components by ultrasonic welding, such as, for example, a) a threaded male plastic button and an abrasive circular disc made of coated abrasives or non-woven abrasives; b) a transverse splicing joint on an endless abrasive belt, made of coated abrasives or non-woven abrasives; c) components of different materials, etc . . .

The provision of a co-laminated insertion film, with or without co-lamination of a cloth liner on the backside of the abrasive fabric, allows rapidly executing joints using ultrasounds only, with an adequate adhesion quality both on steel and plastic.

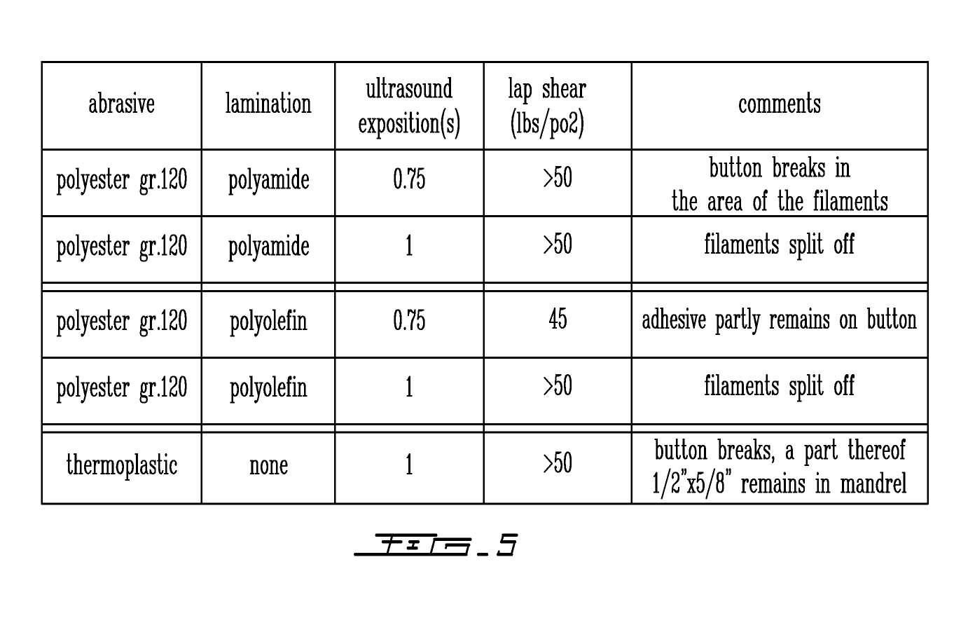

FIG. 5 shows a table of results of lap shear tests on nylon buttons welded on abrasive disk materials. As may be seen from the comments in the last column, the joint itself is strong, the button or filaments of the material breaking before loosening of the joint.

The method allows bonding by ultrasounds a metallic button on an abrasive fabric which has been co-laminated with an insertion film, such as a plastic film, and optionally a cloth liner, without recurring to any adhesive, due to the provision of the co-laminated insertion film, the cloth liner being so selected so as to be sufficiently open weave to allow the melted material of the insertion film to go through at the melting point of the material of the insertion film, under exposure to ultrasounds.

As people in the art will appreciate, the present bonding method is much quicker than when using adhesives, which typically requires lengthy curing times: the duration of the binding process may thus be reduced from hours, when using adhesives, to seconds when using the present method.

The method comprises selecting the materials of the components to be joined according to target applications, in terms of compatibility and reactivity to ultrasounds; selecting an insertion material, i.e. a material sensitive to ultrasounds so as to generate an interfacial bond between the materials of the two components to be welded together in spite of a molecular mismatch; optionally preparing the surfaces of the components to be welded, by cleaning and sanding for example, and defining the texture thereof in order to improve adhesion properties, either chemical and mechanical; adapting the shape and geometry of the ultrasound emitting source; and optimizing the parameters of the exposure to ultrasounds, including pressure, power, and time of exposure, according to the frequency of the ultrasound emitting source, to meet a target adhesion strength or lap shear between the two components to be welded together.

In the case of nylon buttons on abrasive disks for example, it may be possible to achieve a lap shear between the buttons and the abrasive disks of about 50 pounds/square inches by a 1 second ultrasonic exposition (see FIG. 5).

The materials of the components to be welded together may be of thermoplastic and/or of thermoset type, and typically comprise polyolefin, polyamide, polyester or polyurethane. The materials of the components to be welded together may also be metallic, organic, inorganic or other plastics.

When the components to be joined comprise different materials, an insertion material sensitive to ultrasounds is used.

In the case of a transverse joint, this insertion material further provides a filling material at the line of transverse joint, in particular in the case of abrasive belts for example, which contributes to an improved uniform sealing in the transverse axis. As people in the art will appreciate, such improved sealing of the line of transverse joint further secures the joint by preventing an upper layer of the three-dimensional non-woven abrasive material from lifting and coming apart as the belt is in use for example. A target lap shear of the bond is about 30 pounds/square inches under a 1 to 2 seconds ultrasonic exposition, and the step of preparing the surfaces of the components to be welded is minimised.

In the case of two components each having one surface of thermoplastic material, the thermoplastic materials of these surfaces are exposed to ultrasonic welding so that the thermoplastic materials melt in surface and bond together, without insertion material, although an insertion material may be used for stronger results.

In the case of a first component of thermoplastic material and a second component of non-thermoplastic material, a layer of insertion material may be provided on the surface of the non-thermoplastic component to allow bonding with the thermoplastic component. When exposed to ultrasounds, the material of the thermoplastic component and the insertion material of the layer on the second component melt in parallel, with the result that the different components are bonded together.

In the case of non-thermoplastic components, an insertion material sensible to the ultrasonic welding may be provided at the interface to generate proper bonding.

The present method of fastening and joining components by ultrasonic welding allows shorter assembly cycles of the order of one second for an enhanced quality of bonding, with a resulting lap shear of up to 50/lbs/po², and a reduced reject rate due to improved joint uniformity. Moreover, the resulting products, such as abrasive belts, are usable right after assembly, since there is no delay required for post curing, as is the case when using adhesives.

Although the present invention has been described hereinabove by way of embodiments thereof, it may be modified, without departing from the nature and teachings of the subject invention as defined in the appended claims.

What is claimed is:

1. A method for making a joint between a first and a second components using ultrasounds, comprising the steps of:
selecting a first material for the first component and a second material for the second component;
selecting an ultrasound-emitting source;
optimizing parameters of the ultrasound emitting source; and
exposing a region of the joint to ultrasounds emitted by the ultrasound emitting source;
thereby forming a structural interface by melting at the region of the joint between the first and the second components.

2. The method of claim 1, further comprising, before said step of exposing the region of the joint to ultrasounds emitted by the ultrasound emitting source, the steps of:
selecting an insertion material; and
providing a film of the insertion material in the region of the joint.

3. The method of claim 2, wherein said step of providing a film of the insertion material comprises continuously co-laminating a film of the insertion material on a backside of each one of the components, said method further comprising placing a tape overlapping the joint before said step of submitting the region of the joint to ultrasounds.

4. The method of claim 2, wherein said step of providing a film of the insertion material in the region of the joint comprises continuously co-laminating a cloth liner on a backside of each one of the components, with a film of the insertion material sandwiched between the backside and the cloth liner, said method further comprising placing a tape overlapping the joint before said step of submitting the region of the joint to ultrasounds.

5. The method of claim 3, further comprising reinforcing the joint using an additional film on a side of the region of the joint opposite the tape.

6. The method of claim 4, further comprising reinforcing the joint using an additional film on a side of the region of the joint opposite the tape.

7. The method of claim 1, wherein the first material is a first abrasive material, and the second material is a second abrasive material.

8. The method of claim 1, wherein the first material is a first abrasive material, and the second material is one of: i) a metallic and ii) a plastic material.

9. The method of claim 2, wherein said step of providing the film of the insertion material in the region of the joint comprises co-laminating a side of the first component with the insertion material.

10. The method of claim 2, further comprising butting respective ends of the first and second components together, wherein said step of providing the film of the insertion material in the region of the joint comprises placing the insertion material in an overlapping position over the joint.

11. The method of claim 2, wherein the first and second materials are abrasive belt materials, said step of selecting an insertion material comprising selecting a plastic material, said step of providing a film in a region of the joint comprising bringing ends of the components together in a joint and overlapping the joint by the film of the plastic material.

12. The method of claim 2, wherein the first and second materials are abrasive belt materials and the joint is a transverse splicing joint between respective ends of the components, said step of selecting an insertion material comprising selecting a plastic material, said step of providing a film in a region of the joint comprising placing a film of the plastic material in a region of the splicing joint, bringing the ends of the components together in the splicing joint and overlapping the splicing joint by a tape supporting a film of the plastic material on a side thereof facing the splicing joint.

13. The method of claim 2, wherein the first and second materials are abrasive belt materials and the joint is a transverse splicing joint between respective ends of the components, said step of selecting an insertion material comprising selecting a plastic material, said step of providing a film comprising co-laminating a side of each component with the plastic material, bringing the ends of the components together in the splicing joint and overlapping the splicing joint by a tape.

14. The method of claim 1, wherein said step of selecting a first material and a second material comprises selecting an abrasive material and one of: i) metal and ii) plastic material.

15. The method of claim 2, wherein said step of selecting a first material and a second material comprises selecting an abrasive material and one of a: i) metal and ii) plastic material; said step of selecting an insertion material comprising selecting a plastic material, said step of providing a film in a region of the joint comprising laminating the insertion material on a surface of the first component and placing the second component on the laminated surface.

16. The method of claim 2, wherein said step of selecting a first material and a second material comprises selecting for the first component an abrasive material and for the second component one of a: i) metal and ii) plastic material, said step of selecting an insertion material comprising selecting a plastic material, said step of providing a film in a region of the joint comprising depositing a film of the insertion material on a face of the second component facing a surface of the first component, and placing the second component on the surface.

17. The method of any one of claim 7, wherein the abrasive materials are selected in the group consisting of coated abrasive materials and non-woven scrim reinforced abrasive materials.

18. The method of claim 8, wherein the abrasive material is selected in the group consisting of coated abrasive materials and non-woven scrim reinforced abrasive materials.

19. The method of claim 1, further comprising the steps of preparing surfaces of the components to be joined.

20. The method of claim 2, wherein said step of selecting the first and second materials comprises selecting materials in the group consisting of thermoplastic materials, thermoset materials, metallic materials, organic materials and inorganic materials.

21. The method of claim 2, wherein said step of selecting the first and second materials comprises selecting materials in the group consisting of polyolefin, polyamide, polyester, polyurethane, metallic materials, organic materials and inorganic materials.

22. The method of claim 1, wherein said step of selecting the first and second materials comprises selecting components each having one surface of thermoplastic material; the thermoplastic materials of these surfaces, when exposed to the ultrasounds, melting in surface, and bonding together.

23. The method of claim 2, wherein said step of selecting the first and second materials comprises selecting components each having one surface of thermoplastic material; the thermoplastic materials of these surfaces, when exposed to the ultrasounds, melting in surface, and bonding together, the insertion material further strengthening the bond.

24. The method of claim 2, wherein said step of selecting the first and second materials comprises selecting a first component of thermoplastic material and a second component of non-thermoplastic material, said step of selecting an insertion material comprising providing a layer of insertion material on a surface of the non-thermoplastic component; the thermoplastic material of the first component and the insertion material on the second component melting in parallel under exposure to ultrasounds.

25. The method of claim 2, wherein said step of selecting the first and second materials comprises selecting non-thermoplastic components, said step of selecting an insertion material comprising providing an insertion material sensible to ultrasounds at an interface between the components.

26. A joint between a first and a second components made in one of: i) coated abrasive materials and ii) non-woven scrim reinforced abrasive materials, said joint comprising a region of the first component in contact with a region of the second component, and a bond generated by exposure to ultrasounds of a film of ultrasound sensitive material placed in the region of contact.

27. A joint between a first component made in one of: i) coated abrasive materials and ii) non-woven scrim reinforced abrasive materials, and a second component made in one of: i) metallic material and ii) plastic material), said joint comprising a region of the first component in contact with a region of the second component, and an interfacial bond generated by exposure of the region of the first component in contact with the region of the second component to ultrasounds.

28. A joint between a first component made in one of: i) coated abrasive materials and ii) non-woven scrim reinforced abrasive materials, and a second component made in one of: i) metallic material and ii) plastic material), said joint comprising a film of ultrasound sensitive material in contact with both components, and an interfacial bond generated by exposure of the film of ultrasound sensitive material to ultrasounds.

29. The joint of claim 27, wherein said first component is an abrasive disk and said second component is a button.

30. The joint of claim 28, wherein said components are pieces of an abrasive belt, said joint being a transverse joint; said film of material overlapping the transverse joint.

31. The joint of claim 28, wherein said components are pieces of an abrasive belt, and said joint being one of: i) butt joint, and ii) a top joint seal joint.

32. The joint of claim 28, wherein said pieces are abrasive sheets, said regions of the first component and of the second component being profiled ends of each sheet respectively.

33. The method of claim 2, wherein the first material is a first abrasive material, and the second material is a second abrasive material.

34. The method of claim 2, wherein the first material is a first abrasive material, and the second material is one of: i) a metallic and ii) a plastic material.

35. The method of claim 2, further comprising the steps of preparing surfaces of the components to be joined.

36. The method of claim 2, wherein said step of selecting the first and second materials comprises selecting materials in the group consisting of thermoplastic materials, thermoset materials, metallic materials, organic materials and inorganic materials.

37. The method of claim 2, wherein said step of selecting the first and second materials comprises selecting materials in the group consisting of polyolefin, polyamide, polyester, polyurethane, metallic materials, organic materials and inorganic materials.
